(19) United States
(12) Patent Application Publication
(10) Pub. No.: US 2004/0157002 A1
(43) Pub. Date: Aug. 12, 2004

(54) Method for coating a substrate with sealant, sealant before and after hardening, and use of the non-hardened sealant

(76) Inventors: Peter Bons, Reicheisheim (DE); Heinz Burock, Niedernhausen (DE); Francisco Diez, Moerfelden-Walldorf (DE); Andrea Paul, Mainhausen (DE)

Correspondence Address: FULBRIGHT & JAWORSKI, LLP, 666 FIFTH AVE, NEW YORK, NY, 10103-3198, US

(21) Appl. No.: 10/467,841

(22) PCT Filed: Feb. 21, 2002
(86) PCT No.: PCT/EP02/01868

(51) Int. Cl. C08F 2/46

(52) U.S. Cl. 427/487; 427/544

(57) ABSTRACT

The invention relates to a process for coating a substrate with a sealant, in particular for joining or gluing parts or/and sealing off or filling hollow and intermediate spaces, which is characterized in that the not yet cured sealant comprises a latent catalyst which is released or/and formed in the active form under external action of energy and as a result initiates or/and accelerates the reaction between the base polymer and hardener for the curing.

The invention also relates to a non-cured sealant comprising a base polymer and a hardener with a catalyst, in which the catalyst is contained in a latent form and can be released in the active form by external action of energy.

The invention relates to a process for coating a substrate with a sealant, in particular for joining or gluing parts or/and sealing off or filling hollow and intermediate spaces. Above all, this process is of interest for air and space travel, but also in all instances where a long processing time in combination with a shortest possible curing time of the sealant is required.

Sealants are currently employed for the most diverse purposes. They are used in particular for sealing off construction elements, for gluing e.g. metal sheets on to existing structures, such as e.g. segments of an aircraft, or for corrosion protection at places where e.g. in the region of bores the corrosion protection layers of metallic elements are damaged or removed, and can temporarily assume a supporting function, e.g. during transportation of structures undergoing construction which are subsequently also provided with permanent supporting joining elements.

The production and maintenance of air and space vehicles with a large number of joining places with sealants has hitherto been extremely involved, since the sealants employed to date, in particular those with a long processing time, necessitate a very long time for complete curing. A shear strength of 1.8 N/mm² or a Shore A hardness of 30 or 35, measured in accordance with DIN 65262-1, can serve as a criterion for a certain degree of curing. However, complete curing requires much longer times than the curing times to achieve these values of properties.

The disadvantage of known sealants and processes for their processing and curing lies in the fact that for a given processing time to be adhered to, too little catalyst can be incorporated into the sealant to accelerate curing to the desired extent. During long processing times in particular, this means that because of their associated long curing times the sealants severely delay work processes. However, rapid complete curing is also necessary in the case of sealants with a long processing time.

There was the object of ensuring very short curing times while retaining relatively long or long processing times or even while prolonging the processing time.

The sealants currently employed allow a processing time of at most 20 minutes in order to achieve a shear strength of 1.8 N/mm² within 45 minutes during curing. These conditions are achieved only with great effort and particular sealant compositions.

A Shore A hardness of at least 35 or even of only 30, at which the sealant can no longer undergo plastic deformation and no longer smears e.g. during, transportation, is frequently used in addition to or instead of the shear strength as a criterion for a relatively slow-curing sealant undergoing curing to be able to be exposed to mechanical stresses. A typical Shore A hardness for a completely cured sealant is 55±10.

A typical curing time of a high-quality conventional sealant with a relatively long processing time requires e.g. at a processing time of 2 h, a time in the region of 24 h to 48 h to achieve a Shore A hardness of 35. A special sealant with which it has been possible to achieve curing up to 35 Shore A in 9 h in a very specific composition with a processing time of 2 h has become known to the Applicant. The slow-curing high-quality sealant referred to here had cured completely after about 14 days. Such a sealant can be employed e.g. for application of so-called worms and for protection and for sealing off edge profiles.

A typical curing time of a high-quality conventional sealant with a long processing time requires e.g. at a processing time of 48 h in the region of about 30 to 56 days to achieve a Shore A hardness of only 30. The Shore A hardness of 35 is achieved only after further additional days of curing. Such sealants are employed e.g. in aircraft construction as so-called intermediate layer sealants in the fuselage region by application over the area between two metal sheets.

The aim of development of sealants therefore had to be to render possible a processing time of e.g. 48 h without thereby requiring far more than 48 h for curing, since the processing time and curing time in the case of conventional sealants are in principle proportional, the curing time always being a large multiple of the processing time.

There was therefore the object of proposing a sealant and a process for coating substrates with this sealant, with which a given—usually relatively long or long—processing time can be chosen, but with which the curing time can be shortened significantly, as far as possible without impairment of the remaining performance profile. It should be possible to employ the sealant industrially. For use in the air and space travel sector, the sealant should be able to achieve the same high-quality properties as the conventional sealants used for this purpose.

The object is achieved by a process for coating a substrate with a sealant, which is characterized in that the not yet cured sealant comprises a latent catalyst which is released or/and formed in the active form under external action of energy and as a result initiates or/and accelerates the reaction between the base polymer and hardener for the curing.

This sealant is used in particular for joining or gluing parts or/and for sealing off or filling hollow or intermediate spaces. These parts can be e.g. construction elements.

The sealant can be in the form of one component and can already comprise the latent catalyst in the blend. In many cases the sealant is in two-component form, the latent catalyst then being contained in the base mass or/and in the hardener. The sealant could in principle also comprise more than 2 components, but this is usually undesirable. The latent catalyst can preferably already be in the finished form here. However, the catalyst could also initially be present in the form of starting components or/and part-components complementary to each other, which react with one another only later under external action of energy to give the active catalyst.

The catalyst, which is active per se, can be deactivated in at least one of the three ways mentioned in the following:

1. The sealant can comprise a latent catalyst encapsulated in the active form, the encapsulation of which, under external action of energy, is melted, broken open or/and opened or dissolved by a chemical reaction.

2. The sealant can comprise a latent catalyst in a passive form which is deactivated by a protective group and in which the deactivation of the catalyst can be eliminated by external action of energy to split off the protective group and in which the catalyst can thereby be converted into the active form.

3. The sealant can comprise d latent catalyst which can initially be present in the form of starting components or/and part-components complementary to each other, which react with one another only later under external action of energy to give the active catalyst.

The active catalyst formed by the reaction in its turn initiates the reaction between the base polymer and hardener or/and accelerates this reaction.

The heat energy necessary for activation of the latent catalyst can be generated directly by eddy currents in the electrically conductive substrate coated with the sealant, it being possible for a suitable inductor which causes the eddy currents to be positioned at a distance of ≦20 cm from the substrate and for a high-frequency alternating current to flow through the inductor.

The temperature level necessary for activation of the latent catalyst can initially be achieved by a high inductor current within 0.1 to 20 minutes and a temperature level favourable for the curing of the sealant can then be maintained, it being possible, for regulation, for the current which determines the introduction of heat and flows through the inductor optionally to be reduced or/and switched on and off at intervals or/and increased and reduced in pulsed form.

The latent catalyst can be released by the action of electromagnetic radiation, in particular by heat, The heat energy is preferably transferred by an infra-red emitter, as contact heat e.g. by at least one heating mat lying on the reverse of the coated substrate or/and held at a distance or by at least one heating belt. The heat can be introduced not only by direct but also optionally at the same time by indirect resistance heating, inductive heating or/and high-frequency excitation, such as e.g. microwaves or ultrasound.

Inductive heating is particularly suitable, since in this case the eddy currents act only in the coupling materials, such as the components which comprise metallic or electrically conductive material and are coated with the sealant, and the sealants can be heated in a short time and reproducibly in this manner. The induction coils can be integrated in this case in holders, carriers, clamping elements, casings etc. They can be adapted flexibly in their shape to the particular elements and according to the nature of the irradiation required. Thus, for example, an almost accurately pinpointed introduction of heat can be achieved. A particular reproducibility of the introduction of energy can be ensured via inductive heating in particular, since it is possible to regulate the depth of penetration into the metallic or electrically conductive substrates by the frequency of the alternating current and the heat transfer rate via the duration and intensity of the induction current.

An outstanding process for introduction of the heat is direct excitation of the sealant or/and of the latent or/and active catalyst with at least one of their characteristic frequencies. By this means the introduction of energy is carried out significantly more efficiently, since heating does not take place indirectly via the substrate or/and the surroundings.

Any type of introduction of energy suitable for the activation can be chosen in principle, depending on the chemical system of the sealant and of the catalyst or its encapsulation or the type of deactivation. The effect of the encapsulation is preferably ended by high frequency excitation or/and heat.

The latent catalyst can be released in a temperature range from 60 to 120° C., preferably in a temperature range from 75 to 105° C., particularly preferably 80 to 98° C. The curing time to achieve 35 Shore A hardness can be shortened by this means by 10 to 99,95%, in particular by 20 to 99.9%.

The heat can preferably act on the latent catalyst in a period of time of 0.1 to 20 minutes, preferably in a period of time of 0.5 to 12 minutes, in order to release it. For smaller or thinner-walled parts in particular, this time can be under 2 minutes.

It is thus possible to initiate the reaction(s) and start the curing as required, so-called “sealant cure on demand”. It is preferable here if the curing starts as far as possible in the range from 0.05 to 10 minutes after the start of the introduction of energy and curing takes place in the range from 1 to 300 minutes to achieve the shore A hardness of 35.

After the release of the catalyst, the sealant can be charged with a temperature in the range from 40 to 90° C. for the curing time. This helps to accelerate the curing. Under certain circumstances an increase in temperature by about 10° C. here can approximately double the curing reaction.

As substrates to which a sealant is applied or as elements which are brought into contact with a sealant there may be employed metallic materials, such as e.g. aluminium, aluminium-containing alloys, high-grade steel, other steels, copper and copper-containing alloys, magnesium-containing alloys, titanium and titanium-containing alloys, galvanizations and other surface finishings, carbon-rich materials, such as e.g. CFC and CFHC, plastics, in particular plastics with conductive inserts or with contents of electrically conductive polymers, stone, artificial stone, cement, concrete, glass, ceramic and coated materials, in particular those with a coating to prevent corrosion, based on a primer, a zinc-containing primer or/and at least one lacquer or a similar polymeric coating.

The extrusion rate, which can be determined by squirting a sealant out of a cartridge under 6.2 bar in accordance with DIN 65262-1, is a measure of the processing time.

The sealants according to the invention have an extrusion rate in the range from 15 to 4,000 g/min, preferably in the range from 30 to 2,000 g/min, particularly preferably in the range from 50 to 1,000 g/min.

After the so-called tack-free time TFT, the sealant is no longer tacky and a polyethylene film can then be peeled off without residue from the sealant surface in accordance with DIN 65262-1. The sealants according to the invention have a tack-free time in the range from 3 to 60 minutes, preferably in the range from 4 to 30 minutes, particularly preferably in the range from 5 to 15 minutes.

The sealant according to the invention can be applied to the substrates by the methods which are known in principle, such as e.g. by spraying on, rolling on, brushing on, knife-coating on or trowelling on.

The object is also achieved by a non-cured sealant, which can be in its state before or after the start of curing, comprising a base polymer and a hardener together with a catalyst, which is characterized in that the catalyst is contained in a latent form and can be released in the active form by external action of energy, In two-component systems, the catalyst can be contained in the base mass, in the hardener or in both.

The latent catalyst can be contained in the non-cured sealant encapsulated in the active form, in particular in a polymeric shell.

The latent catalyst can be contained in the non-cured sealant in a passive form deactivated by a protective group. The deactivation of the catalyst can be eliminated by external action of energy to split off the protective group, and the catalyst can then be converted into the active form.

The non-cured sealant can comprise a latent catalyst which is initially present in the form of starting components or/and part-components complementary to each other, which react with one another only later under external action of energy to give the active catalyst. The active catalyst formed by this reaction in its turn initiates the reaction between the base polymer and hardener or/and accelerates this reaction.

The composition of the sealant according to the invention is known in principle—apart from the catalysts or components thereof and the encapsulation. The non-cured sealant will often also comprise, in addition to the base polymer, the hardener and the optionally encapsulated catalyst, at least one accelerator, at least one adhesion promoter, at least one filler, under certain circumstances in the form of hollow packing, optionally at least one retardant, optionally at least one rheologically active additive, e.g. to adapt the viscosity or thixotropy, and optionally at least one additive which influences the surface, such as e.g. at least one surfactant, optionally at least one defoamer or/and optionally at least on corrosion inhibitor—in particular a chromate-free corrosion inhibitor.

The non-cured sealant can be used for gluing parts and optionally sealing off, in particular in air and space travel.

It can contain as the chemical basis (base polymer, binder) at least one mercapto-terminated polymer—in particular a mercapto-terminated polysulfide, a mercapto-terminated polythioether or/and a mercapto-terminated polyether—together with at least one acrylate, at least one isocyanate or/and with at least one epoxy resin as the crosslinking agent and optionally together with at least one crosslinking agent polyfunctionalized by mercapto or/and with at least one hydroxy-functionalized crosslinking agent.

It can contain as the chemical basis at least one acrylate-terminated polymer—in particular an acrylate-terminated polysulfide, an acrylate-terminated polythioether or/and an acrylate-terminated polyether—together with at least one mercapto-terminated polymer—in particular a mercapto-terminated polysulfide, a mercapto-terminated polythioether or/and a mercapto-terminated polyether—or/and with at least one crosslinking agent polyfunctionalized by mercapto.

It can contain as the chemical basis at least one mercapto-terminated polymer—in particular a mercapto-terminated polysulfide, a mercapto-terminated polythioether or/and a mercapto-terminated polyether—and at least one oxygen donor—as the oxygen donor preferably a manganese-containing oxide, such as manganese dioxide, a peroxide, in particular of an alkaline earth metal, a perborate or/and cumene hydroperoxide.

The crosslinking agent polyfunctionalized by mercapto can be e.g. trimethylolpropane trimercaptoacetate or/and pentaerythritol tetra-3-mercaptopropionate.

It can contain as the chemical basis at least one polyol or/and a hydroxy-functionalized polymer—in particular a hydroxy-functionalized polysulfide, a hydroxy-functionalized polythioether, a hydroxy-functionalized polyether or/and hydroxy-functionalized polyester—and at least one isocyanate as the crosslinking agent.

Isophorone-diisocyanate IPDI, MDI, toluene-diisocyanate TDI or/and prepolymers of these isocyanates are preferred in particular as the isocyanate.

The content of base polymer and crosslinking agents (hardeners) can vary within wide ranges, in particular between 38 and 99.5 wt. %, preferably in the range from 50 to 98 wt. %, particularly preferably in the range from 60 to 92 wt. %. This content is preferably at least 65 wt. %, particularly preferably at least 70 wt. % and very particularly preferably at least 75 wt. %. This content is preferably not more than 95 wt. %, particularly preferably not more than 90 wt. % and very particularly preferably not more than 85 wt. %. It is also determined above all by the content of fillers and furthermore of catalysts. The content of crosslinking agents is preferably in the range from 5 to 60 wt. %, particularly preferably in the range from 8 to 50 wt. %, and is, in particular, at least 10 or 12 wt. % or not more than 40 or 30 wt. %. The content of oxygen donors, if these are added, is preferably in the range from 1 to 25 wt. %, particularly preferably in the range from 4 to 15 wt. %, and is, in particular, at least 6 wt. % or not more than 10 wt. %.

The non-cured sealant can comprise as the active catalyst at least one organic nitrogen compound, at least one organometallic compound or/and at least one metal oxide and can optionally have a polymeric shell as encapsulation. An aliphatic, cycloaliphatic or/and aromatic amine, a polyamine, an amide, a polyamide or/and an imidazole can serve e.g. as the organic nitrogen compound, an organometallic compound of iron, titanium, bismuth or/and tin or e.g. a laurate, an octoate or/and an acetylacetonate can be used e.g. as the organometallic compound and at least one metal oxide of barium, magnesium or/and zinc can be used e.g. as the metal oxide.

The polymeric shell surrounding the catalyst can be such that before the external action of energy it cannot melt below 40° C., nor can it be attacked chemically by the surrounding substances in this temperature range, the catalyst not being able to emerge from the polymeric shell by diffusion before the external action of energy.

The active catalyst can be present on the basis of at least one nitrogen compound, such as e.g. an amine, and can be blocked by reaction with at least one H-acid compound, such as e.g. an acid or/and a phenol. By this reaction, which leads to an adduct or/and a salt, the active catalyst becomes a latent passive catalyst. The reaction can be reversed by external action of energy, the active catalyst being released.

Before the excitation, the encapsulated active catalysts are usually present in a state which is not very active or completely inactive. They usually allow a relatively long processing time of the sealant e.g. of at least 1 hour. They can be employed in a tightly encapsulated form or with a weaker encapsulation which also allows a certain reactivity before the excitation/release.

The passive catalysts provided with a protective group are usually very active after their activation and often have somewhat shorter processing times than the encapsulated active catalysts.

In many cases it is true here for the catalysts that the processing time of the sealant is somewhat shorter the shorter their curing time.

The content of catalyst(s) is—in each case including any content of the encapsulation—preferably in the range from 0.001 to 15 wt. %, particularly preferably in the range from 0.1 to 10 wt. %, and is, in particular, at least 0.3 or 0.5 wt. % or not more than 5 or 3 wt. %. Higher contents are often employed here because of the encapsulation.

The non-cured sealant can moreover also contain fillers and in each case if required also drying agents or/and other additives.

Fillers which can be used are all the generally known fillers, such as also e.g. calcium silicates, chalk or/and carbon black. The content of fillers can, when these are added, preferably be in the range from 2 to 60 wt. %, particularly preferably in the range from 5 to 50 wt. %, and is, in particular, at least 10 or 20 wt. % or not more than 40 or 30 wt. %. A minimum content can also be added to achieve colouration of the mass.

Drying agents are advantageously employed when isocyanates or prepolymers thereof are used if foaming is to be avoided. Their content is then preferably in the range from 0.1 to 6 wt. %, particularly preferably in the range from 1 to 4 wt. %. Alternatively, however, 20 slightly foamed sealants to which no or too little drying agent has been added can also be used.

The non-cured sealant can cure with a ratio of the curing time to the processing time of ≦4:1.8 h of curing time and 2 h of processing time correspond e.g. to a ratio of the curing time to the processing time of 4:1. This ratio is preferably ≦2.5:1 (e.g. 1.25 h: 0.5 h), particularly preferably ≦1:1 (e.g. 1 h:1 h), above all ≦0.5:1′ (e.g. 16 h: 48 h). Surprisingly, chemical systems have been found with which it is possible to achieve a ratio of the curing time to the processing time of ≦1:1 (e.g. 1 h: 12 h) or even ≦0.05:1 (e.g. 1 h; 24 h) or even ≦0.005:1 (e.g. 1 h:200 h).

A long processing time of e.g. 60 hours may be advantageous in order e.g. for the sealant to be able to be squeezed out during preparation and for carrying out riveting of aircraft fuselages by application of the sealant, bringing together of at least two construction elements, pressing on of the construction elements and riveting. After riveting and distribution of the sealant during riveting, a rapid curing of the sealant is then usually required for further work processes.

The non-cured sealant can have a shear strength of at least 1 N/mm² in up to 1 h from release of the latent catalyst, preferably a shear strength of at least 2 N/mm² in 40 minutes or even in 30 minutes. After this time the sealant has not yet achieved its final strength, that is to say is not yet completely cured.

The object is furthermore achieved by a cured sealant prepared according to the invention, which can be largely or completely cured, and which is characterized in that after complete curing it achieves a shear strength of at least 2 N/mm², preferably at least 2.5 N/mm², particularly preferably at least 3 N/mm².

The cured sealant can have a chemical resistance as required in AIMS 04-05-001. The chemical resistance can be characterized by a minimum peel strength of at least 65 N/25 mm either after 7 days at 60° C. in fuel (in accordance with ISO 1817) or after 7 days at 23° C. in de-icing liquid (in accordance with ISO 11075 type 1) or after 1,000 hours in demineralized water at 35° C. or after storage in heat at 80° C. for 2,000 hours.

It can have an elongation at break at room temperature of at least 150%, measured in accordance with DIN 65262-1.

It can have a low temperature flexibility, measured at −55° C. in accordance with ISO 1519 or EN 3102.

The non-cured sealant can be used in particular for the construction and maintenance of air and space vehicles and of automobiles and rail vehicles, in shipbuilding, in apparatus and machinery construction, in construction or for the production of furniture. It is particularly suitable for fixing and attaching so-called clips before riveting, e.g. for transportation, in air and space vehicles.

### EXAMPLES

### Examples 1 and 2 on Inductive Curing

TABLE 1
Composition of the base mass of B1 and B2

| | Raw materials in wt. % | B1 | B2 |
|---|---|---|---|
| 1 | OH-terminated polysulfide | 69.64 | 74.92 |
| | (OH number ≈ 80) | | |
| 2 | 1,4-Butanediol | 1.42 | 1.53 |
| 3 | Sylosiv A3 | 1.42 | 1.53 |
| 4 | Tremin 283/600 EST | 19.90 | 13.76 |
| 5 | Luvocarb MT-LS | 7.10 | 7.65 |
| 6 | Polycat SA 102/10 | 0.52 | 0.61 |
| | (10% in Santicizer 160) | | |
| 7 | Suprasec 2030 | 19.74 | 19.11 |

Component 2 serves here as a crosslinking agent, component 3 as a drying agent to avoid foaming, components 4 and 5 as fillers, component 6 as a catalyst with protective groups and component 7 as a hardener based on MDI. A base mass was prepared from components 1 to 6 and was mixed with component 7 with the aid of a spatula. Using the non-cured sealant, aluminium shear test specimens with an overlapping area of 25.0×25.0 mm and a layer thickness of 0.15 mm were produced.

The shear test specimens were heated inductively for two minutes at approximately one kW. The mass had then reacted to the extent that a weight of approximately 100 g could be held. The blend was still liquid after 35 min at room temperature. The inductively heated shear test specimens were stored for 25 to 45 minutes at room temperature before testing of the shear strength.

TABLE 2
Test results on the reacted sealant of B1
and B2

| Test | B1 | B2 |
|---|---|---|
| Tack-free time after heating in min | 2 | 2 |
| Processing time at room temperature in min, | 35 | 35 |
| approximately | | |
| Shear strength in N/mm² | 2.40 | 1.47 |
| Fracture pattern in % cohesion loss | 100 | 100 |

The ratio of curing time to processing time here was 0.05; 1. It was moreover assumed that the chemical resistance in accordance with AIMS 04-05-001 and the low temperature flexibility at −55° C. in the mandrel flex test were achieved.

### Examples 3, 4 and 5 on Curing With Microwaves

TABLE 3
Composition of the base masses of examples 3 to 5

| | Raw materials in wt. % | B3 | B4 | B5 |
|---|---|---|---|---|
| 1 | OH-terminated polysulfide | 92.60 | — | — |
| | (OH number ≈ 70) | | | |
| 2 | Thioplast G 10 | — | 56.08 | — |
| 3 | Thiokol LP 33 | — | 37.38 | — |
| 4 | Thiokol LP 980 | — | — | 95.33 |
| 5 | 1,4-Butanediol | 1.85 | 1.87 | — |
| 6 | Sylosiv A3 | 3.70 | 3.74 | 3.74 |
| 7 | Encapsulated aminic | 1.85 | 0.93 | 0.93 |
| | accelerator | | | |
| 8 | Suprasec 2015 | 27.20 | — | 14.80 |
| 9 | Baymidur KL3-5002 | — | 14.60 | — |

Components 2 to 4 are mercapto-terminated polysulfides, component 5 serves here as a crosslinking agent, component 6 as a drying agent for avoiding foaming, component 7 as a catalyst and component 8 or 9 as a hardener based on MDI. Components 1 to 7 were weighed into a beaker and mixed intensively with a spatula. Components 8 or 9 were then added and the mixture was homogenized. The batch in the beaker stood at room temperature in order to measure the processing time, i.e. the time the material remains liquid. Approximately 1 to 2 g of the material were applied in a thin layer to a specimen holder directly after mixing and activated in a microwave oven at an output of 1,200 W. The microwave impulse caused the capsules of the aminic accelerator to burst and initiated the chemical reactions by releasing the accelerator. The time required to cure the material was measured.

TABLE 4
Test results on the reacted sealants B3 to B5

| Test | B3 | B4 | B5 |
|---|---|---|---|
| Curing time required in | 20 s | 20 s | 20 s |
| the microwave oven | | | |
| Tack-free time | 20 s | 20 s | 20 s |
| Processing time at | >2 h | >2 h | >2 h |
| room temperature | | | |

The ratio of curing time to processing time was 0.003:1. It is moreover assumed that the chemical resistance in accordance with AIMS 04-05-001 and the low temperature flexibility at −55° C. in the mandrel flex test were achieved.

In all the examples it was surprising that it was readily possible to achieve a short curing with a comparatively long processing time in such a manner, and also to achieve outstanding properties of the sealants.

1. Process for coating a substrate with a sealant, in particular for joining or gluing parts or/and sealing off or filling hollow and intermediate spaces, characterized in that the not yet cured sealant comprises a latent catalyst which is released or/and formed in the active form under external action of energy and as a result initiates or/and accelerates the reaction between the base polymer and hardener for the curing.

2. Process according to claim 1, characterized in that the sealant comprises a latent catalyst encapsulated in the active form, the encapsulation of which, under external action of energy, is melted, broken open or/and opened or dissolved by a chemical reaction.

3. Process according to claim 1, characterized in that the sealant comprises a latent catalyst in a passive form which is deactivated by a protective group, and in that the deactivation of the catalyst is eliminated by external action of energy to split off the protective group and the catalyst is converted into the active form.

4. Process according to claim 1, characterized in that the sealant comprises a latent catalyst which is initially present in the form of starting components or/and part-components complementary to each other, which react with one another only later under external action of energy to give the active catalyst.

5. Process according to one of the preceding claims, characterized in that the latent catalyst is released by the action of electromagnetic radiation, in particular by heat, preferably by intra-red radiation, contact heat, direct or/and indirect resistance heating, inductive heating or high frequency excitation, such as e.g. microwaves or ultrasound.

6. Process according to one of the preceding claims, characterized in that the latent catalyst is released in a temperature range from 60 to 120° C., preferably in a temperature range from 75 to 95° C.

7. Process according to one of the preceding claims, characterized in that the heat acts on the latent catalyst in a period of time of 0.1 to 20 minutes, in order to release it.

8. Process according to one of the preceding claims, characterized in that after release of the catalyst the sealant is charged with a temperature in the range from 40 to 90° C. for the curing time.

9. Process according to one of the preceding claims, characterized in that the heat energy necessary for activation of the latent catalyst is generated by eddy currents directly in the electrically conductive substrate coated with the sealant, a suitable inductor which causes the eddy currents being positioned at a distance of ≦20 cm from the substrate and a high frequency alternating current flowing though the inductor.

10. Process according to one of the preceding claims, characterized in that the temperature level necessary for activation of the latent catalyst is initially achieved by a high inductor current within 0.1 to 20 minutes and a temperature level favourable for the curing of the sealant is then maintained, the current which determines the introduction of heat and flows though the inductor optionally, for regulation, being reduced or/and switched on and off at intervals or/and increased and reduced in a pulsed manner.

11. Process according to one of the preceding claims, characterized in that the sealant or/and the latent or/and active catalyst is excited directly with at least one of their characteristic frequencies.

12. Non-cured sealant comprising a base polymer and a hardener with a catalyst, characterized in that the catalyst is contained in a latent form and can be released in the active form by external action of energy.

13. Non-cured sealant according to claim 12, characterized in that the latent catalyst is contained encapsulated in the active form, in particular in a polymeric shell.

14. Non-cured sealant according to claim 12, characterized in that the latent catalyst is contained in a passive form deactivated by a protective group, and in that the deactivation of the catalyst can be eliminated by external action of energy to split off the protective group and the catalyst can be converted into the active form.

15. Non-cured sealant according to claim 12, characterized in that it comprises a latent catalyst which is initially present in the form of starting components or/and part-components complementary to each other, which react with one another only later under external action of energy to give the active catalyst.

16. Non-cured sealant according to one of claims 12 to 15, characterized in that it is a sealant for gluing parts and is optionally used for sealing off, in particular in air and space travel.

17. Non-cured sealant according to one of claims 12 to 16, characterized in that it contains as the chemical basis at least one mercapto-terminated polymer together with at least one acrylate, with at least one isocyanate or/and with at least one epoxy resin and together with at least one crosslinking agent polyfunctionalized by mercapto.

18. Non-cured sealant according to one of claims 12 to 17, characterized in that it contains as the chemical basis at least one acrylate-terminated polymer together with at least one mercapto-terminated polymer or/and with at least one crosslinking agent polyfunctionalized by mercapto.

19. Non-cured sealant according to one of claims 12 to 18, characterized in that it contains as the chemical basis at least one mercapto-terminated polymer and at least one oxygen donor.

20. Non-cured sealant according to one of claims 12 to 19, characterized in that it contains as the chemical basis at least one polyol or/and at least one hydroxy-functionalized polymer and at least one isocyanate.

21. Non-cured sealant according to one of claims 12 to 20, characterized in that it comprises as the active catalyst at least one organic nitrogen compound, at least one organometallic compound or/and at least one metal oxide and optionally has a polymeric shell as encapsulation.

22. Non-cured sealant according to claim 21, characterized in that the polymeric shell surrounding the catalyst cannot melt below 40° C. before the external action of energy, nor can it be attacked chemically by the surrounding substances in this temperature range, and in that the catalyst cannot emerge from the polymeric shell by diffusion before the external action of energy.

23. Non-cured sealant according to one of claims 12 to 22, characterized in that an active catalyst based on at least one nitrogen compound, such as e.g. an amine, is blocked by reaction with at least one H-acid compound, such as e.g. an acid or/and a phenol.

24. Non-cured sealant according to one of claims 12 to 23, characterized in that it has a shear strength of at least 1 N/mm² in up to 1 h from release of the latent catalyst.

25. Non-cured sealant with a ratio of the curing time to the processing time of <4:1.

26. Cured sealant prepared according to one of claims 1 to 11 or/and prepared from a non-cured sealant according to one of claims 12 to 25, characterized in that it has achieved a shear strength of at least 2 N/mm² after complete curing.

27. Cured sealant according to claim 26, characterized in that it has a chemical resistance as required in AIMS 04-05-001.

28. Cured sealant according to claim 26 or 27, characterized in that it has an elongation at break at room temperature of at least 150%, measured in accordance with DIN 65262-1.

29. Cured sealant according to one of claims 26 to 28, characterized in that it has a low temperature flexibility measured in the mandrel flex test at −55° C.

30. Use of a non-cured sealant prepared according to one of claims 1 to 11 for the construction and maintenance of air and space vehicles and of automobiles and rail vehicles, in shipbuilding, in apparatus and machinery construction, in construction, and for the production of furniture.

31. Use of a non-cured sealant according to one of claims 12 to 25 for the construction and maintenance of air and space vehicles and of automobiles and rail vehicles, in shipbuilding, in apparatus and machinery construction, in construction, and for the production of furniture.
